(19) United States
(12) Patent Application Publication
(10) Pub. No.: US 2025/0050663 A1
(43) Pub. Date: Feb. 13, 2025

(54) IMAGE FORMATION CONTROL METHOD AND IMAGE FORMING APPARATUS

(71) Applicant: KYOCERA Document Solutions Inc., Osaka (JP)

(72) Inventors: Takuya Fukata, Osaka (JP); Hiroki Takehana, Osaka (JP)

(21) Appl. No.: 18/788,845

(22) Filed: Jul. 30, 2024

(30) Foreign Application Priority Data
Aug. 8, 2023 (JP) 2023-128969

(51) Int. Cl. B41J 13/00; B41J 11/66; B41J 11/70; B41J 13/08

(52) U.S. Cl. CPC B41J 13/0018; B41J 11/663; B41J 11/70; B41J 13/08

(57) ABSTRACT

A roll paper supply device rolls out roll paper and cuts the rolled-out portion of the roll paper to produce a first sheet. A control device determines, for each print process, whether or not the roll paper supply device is in a specific state in which the roll paper supply device has conveyed the first sheet to a specific position. When it is determined that the roll paper supply device is in the specific state, the control device causes the roll paper supply device to execute a process of conveying the first sheet to a print position. When it is determined that the roll paper supply device is not in the specific state, the control device causes a cut sheet supply device to execute a process of conveying a second sheet to the print position.

### INCORPORATION BY REFERENCE

This application is based upon and claims the benefit of priority from the corresponding Japanese Patent Application No. 2023-128969 filed on Aug. 8, 2023, the entire contents of which are incorporated herein by reference.

### BACKGROUND

The present disclosure relates to an image forming apparatus including a device for cutting and supplying a portion of roll paper and a device for supplying a cut sheet, and an image formation control method for controlling the image forming apparatus.

The image forming apparatus includes a printing device that executes a print process. The print process is a process of forming an image on a sheet conveyed to a print position. The image forming apparatus may include a roll paper supply device and a cut sheet supply device.

The roll paper supply device rolls out roll paper, produces a sheet of a specific size by cutting the rolled-out portion of the roll paper, and conveys the produced sheet toward the print position.

The cut sheet supply device conveys a cut sheet accommodated in an accommodating portion toward the print position. The cut sheet is a sheet formed in advance to a standard size.

### SUMMARY

An image formation control method according to one aspect of the present disclosure is a method for controlling an image forming apparatus. The image forming apparatus includes a roll paper supply device, a cut sheet supply device, and a printing device. The roll paper supply device can roll out roll paper, produce a first sheet of a specific size by cutting a rolled-out portion of the roll paper, and convey the first sheet toward a print position. The cut sheet supply device can convey a second sheet of the specific size accommodated in an accommodating portion toward the print position. The printing device can execute a print process of forming an image on the first sheet or the second sheet at the print position. The image formation control method is a control method performed when continuous print processing in which the print process is repeated a plurality of times is executed. The image formation control method includes determining, by a control device, whether or not the roll paper supply device is in a specific state in which the roll paper supply device has conveyed the first sheet to a specific position, for each of the printing processes. The image formation control method further includes causing, by the control device, the roll paper supply device to execute, for each of the print processes, a process of conveying the first sheet to the print position when it is determined that the roll paper supply device is in the specific state. The image formation control method further includes causing, by the control device, the roll paper supply device to execute, for each of the print processes, a process of conveying the second sheet to the print position when it is determined that the roll paper supply device is not in the specific state.

An image forming apparatus according to another aspect of the present disclosure includes the roll paper supply device, the cut sheet supply device, the printing device, and the control device configured to implement the image formation control method.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic configuration diagram of an image forming apparatus according to an embodiment.

FIG. 2 is a configuration diagram of a part of a roll paper supply device and a cut sheet supply device in the image forming apparatus according to the embodiment.

FIG. 3 is a configuration diagram of a printing device in the image forming apparatus according to the embodiment.

FIG. 4 is a block diagram showing a configuration of a control device in the image forming apparatus according to the embodiment.

FIG. 5 is a flowchart showing an example of the procedure of sheet supply control in the image forming apparatus according to the embodiment.

### DETAILED DESCRIPTION

Hereinafter, an embodiment of the present disclosure will be described with reference to the drawings. It is noted that the following embodiment is an example of embodying the present disclosure and does not limit the technical scope of the present disclosure.

[Configuration of Image Forming Apparatus 10]

An image forming apparatus 10 according to the embodiment can execute a print process of forming an image on a sheet.

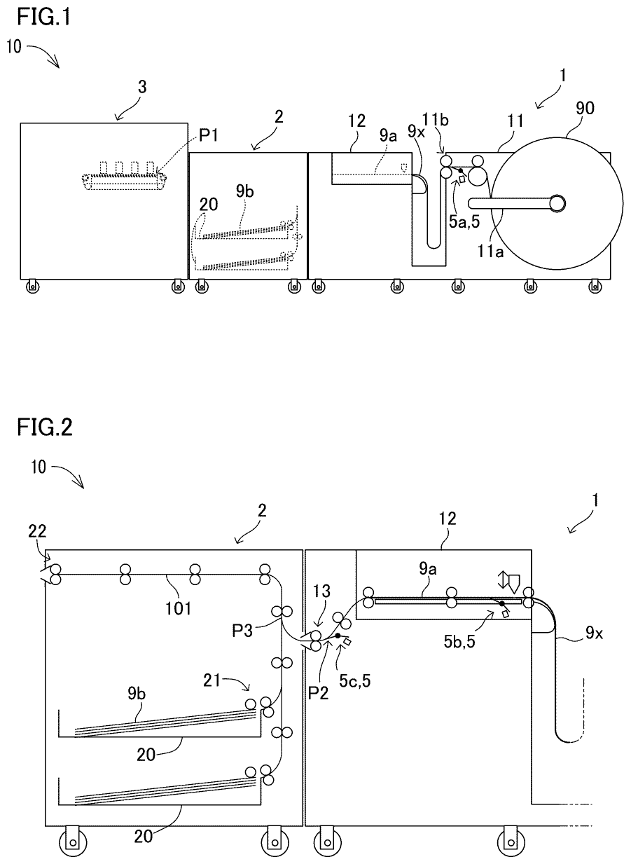

The image forming apparatus 10 includes a roll paper supply device 1, a cut sheet supply device 2, and a printing device 3. As shown in FIG. 1, the roll paper supply device 1, the cut sheet supply device 2, and the printing device 3 are provided.

The roll paper supply device 1 rolls out roll paper 90 and cuts the rolled-out portion of the roll paper 90 to produce a first sheet 9a of a specific size.

Further, the roll paper supply device 1 conveys the produced first sheet 9a toward a print position P1. The print position P1 is a position on a sheet conveying path in the printing device 3.

The roll paper supply device 1 includes a rollout device 11 that rolls out the roll paper 90 and a cutting device 12 that cuts the rolled-out portion 9x of the roll paper 90. The rolled-out portion 9x is a portion of the roll paper 90 that has been rolled out.

The rollout device 11 includes a roll paper support mechanism 11a and a rollout mechanism 11b (see FIG. 1). The roll paper support mechanism 11a rotatably supports the roll paper 90. The rollout mechanism 11b rolls out a portion of the roll paper 90 supported by the roll paper support mechanism 11a.

The cutting device 12 cuts the rolled-out portion 9x of the roll paper 90 to produce a first sheet 9a.

The roll paper supply device 1 further includes a first feeding mechanism 13 (see FIG. 1 and FIG. 2). The first feeding mechanism 13 conveys the first sheet 9a to a pre-stage conveying path 101 in the cut sheet supply device 2. The pre-stage conveying path 101 is a part of the sheet conveying path toward the print position P1.

The cut sheet supply device 2 can convey a second sheet 9b of the specific size accommodated in one or more accommodating portions 20 toward the print position P1. The second sheet 9b is a cut sheet formed in advance to the specific size.

The cut sheet supply device 2 includes one or more accommodating portions 20, a second feeding mechanism 21, and a pre-stage conveying mechanism 22. The second feeding mechanism 21 conveys the second sheet 9b in the accommodating portion 20 to the pre-stage conveying path 101.

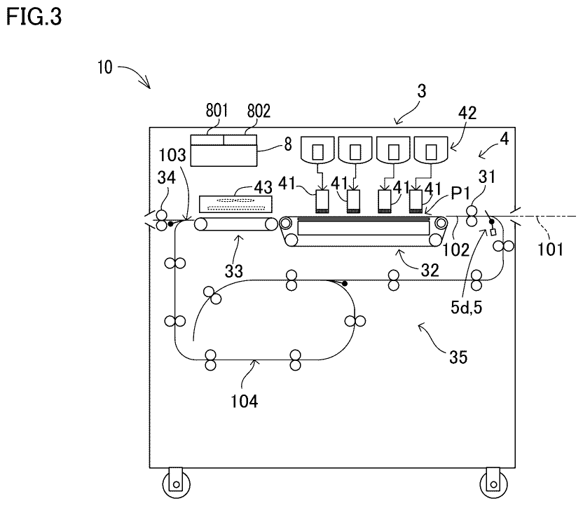

The pre-stage conveying mechanism 22 conveys the first sheet 9a or the second sheet 9b from the pre-stage conveying path 101 to a relay conveying path 102 in the printing device 3 (see FIG. 2 and FIG. 3).

The printing device 3 performs the print process on the first sheet 9a or the second sheet 9b at the print position P1.

The printing device 3 includes a relay conveying mechanism 31, a first belt conveying mechanism 32, a second belt conveying mechanism 33, a post-stage conveying mechanism 34, and an image forming portion 4 (see FIG. 3).

In the present embodiment, the printing device 3 executes the print process using an inkjet method. Therefore, the image forming portion 4 includes a plurality of inkjet units 41 and an ink supply portion 42. The image forming portion 4 also includes a drying device 43.

The relay conveying mechanism 31 conveys the first sheet 9a or the second sheet 9b conveyed into the relay conveying path 102 to the print position P1. The first belt conveying mechanism 32 conveys the first sheet 9a or the second sheet 9b at the print position P1.

Further, the first belt conveying mechanism 32 sends out the first sheet 9a or the second sheet 9b to the second belt conveying mechanism 33. The second belt conveying mechanism 33 conveys the first sheet 9a or the second sheet 9b to a post-stage conveying path 103.

The post-stage conveying mechanism 34 sends out the first sheet 9a or the second sheet 9b to a post-stage device connected subsequently to the printing device 3.

For example, the post-stage device is a discharge tray, a post-processing device, or the like.

The post-processing device performs various types of post-processing on the first sheet 9a or the second sheet 9b on which an image has been formed. For example, the post-processing may be some or all of punching, stapling, and folding.

The plurality of inkjet units 41 form an ink image on the first sheet 9a or the second sheet 9b conveyed by the first belt conveying mechanism 32 by ejecting ink of different colors.

The ink supply portion 42 supplies the plurality of inkjet units 41 with ink of respective colors. The drying device 43 sends hot air to the ink image on the first sheet 9a or the second sheet 9b conveyed by the second belt conveying mechanism 33 to dry the ink image.

The printing device 3 further includes a reverse conveying mechanism 35 (see FIG. 3). When a double-sided print process is executed, the reverse conveying mechanism 35 conveys the first sheet 9a or the second sheet 9b from the post-stage conveying path 103 to the relay conveying path 102 via a reverse conveying path 104.

The reverse conveying mechanism 35 reverses the direction of the first sheet 9a or the second sheet 9b on the reverse conveying path 104, and conveys the reversed first sheet 9a or the second sheet 9b to the relay conveying path 102.

The image forming apparatus 10 further includes a plurality of sheet sensors 5 for detecting a sheet at a plurality of positions on the sheet conveying path, respectively (see FIG. 1 to FIG. 3).

For example, the plurality of sheet sensors 5 include a first sheet sensor 5a, a second sheet sensor 5b, a third sheet sensor 5c, and a fourth sheet sensor 5d (see FIG. 1 to FIG. 3).

The first sheet sensor 5a detects the sheet at a position between the roll paper support mechanism 11a and the cutting device 12 on the roll paper conveying path (see FIG. 1). The first sheet sensor 5a is used to determine whether or not the roll paper 90 is out of paper.

The second sheet sensor 5b detects the sheet at a specific position in the cutting device 12 on the roll paper conveying path (see FIG. 2). The second sheet sensor 5b is used for identifying the cut point of the rolled-out portion 9x of the roll paper 90.

The third sheet sensor 5c detects the first sheet 9a at a specific position P2 on the conveying path of the first sheet 9a (see FIG. 2). The specific position P2 is a position between the cutting device 12 and the pre-stage conveying path 101.

The fourth sheet sensor 5d detects the first sheet 9a or the second sheet 9b on the relay conveying path 102 (see FIG. 3). The fourth sheet sensor 5d is used to control the timing at which the first sheet 9a or the second sheet 9b is sent out to the print position P1 by the relay conveying mechanism 31.

The image forming apparatus 10 further includes an operation device 801, a display device 802, and a control device 8 (see FIG. 3). In the example shown in FIG. 3, the operation device 801, the display device 802, and the control device 8 are provided in the printing device 3.

However, some or all of the operation device 801, the display device 802, and the control device 8 may be provided in the roll paper supply device 1 or the cut sheet supply device 2.

The operation device 801 detects a human operation. For example, the operation device 801 includes a plurality of operation buttons and a touch panel. The display device 802 can display various types of information. For example, the display device 802 is a panel display device such as a liquid crystal display panel.

The control device 8 controls the roll paper supply device 1, the cut sheet supply device 2, and the printing device 3.

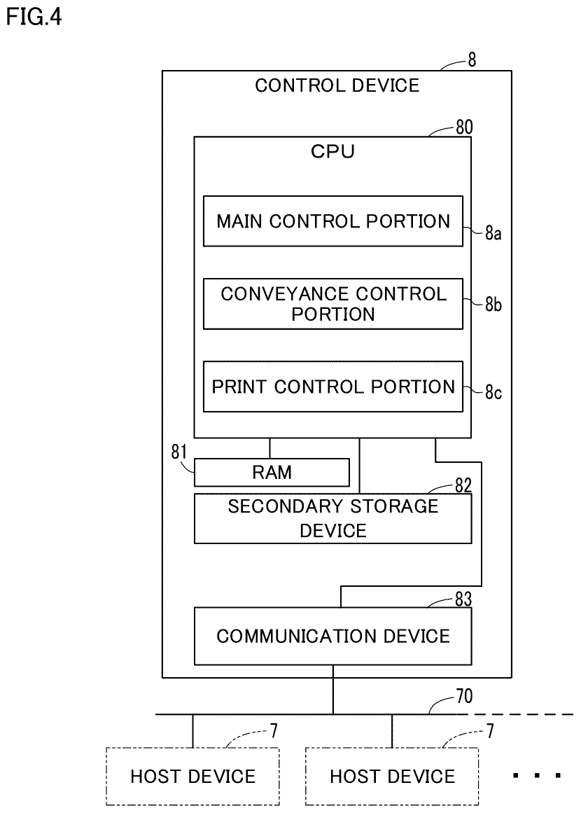

As shown in FIG. 4, the control device 8 includes a central processing unit (CPU) 80, a random access memory (RAM) 81, a secondary storage device 82, a communication device 83, and the like.

The CPU 80 executes various types of control and data processing by executing computer programs. The RAM 81 temporarily stores the computer programs executed by the CPU 80 and various types of data.

The secondary storage device 82 is a computer-readable nonvolatile storage device. The secondary storage device 82 stores the computer programs executed by the CPU 80 and various types of data. For example, one or both of a flash memory and a hard disk drive are employed as the secondary storage device 82.

The communication device 83 executes communication with another device, such as a host device 7, through a network 70. The CPU 80 executes communication with another device through the communication device 83. The host device 7 is an information processing device that requests the image forming apparatus 10 to perform the print process.

The CPU 80 includes a plurality of processing modules implemented by executing the computer programs. The plurality of processing modules include a main control portion 8a, a conveyance control portion 8b, a print control portion 8c, and the like (see FIG. 4).

The main control portion 8a executes start control and the like for starting various processes in response to operations to the operation device 801 or processing requests received through the communication device 83.

The conveyance control portion 8b controls the rollout device 11 and the cutting device 12 to control the production of the first sheet 9a. Further, the conveyance control portion 8b controls the conveyance of the first sheet 9a and the second sheet 9b by controlling devices related to the conveyance of sheets in the first feeding mechanism 13, the cut sheet supply device 2, and the printing device 3.

The print control portion 8c causes the printing device 3 to execute the print process in synchronization with the conveyance of the first sheet 9a and the second sheet 9b. Further, the print control portion 8c controls the power supply to a heater of the drying device 43.

By the way, the user usually selects which of the first sheet 9a and second sheet 9b is to be used in the print process. When continuous print processing in which the print process is repeated a plurality of times is executed, the roll paper supply device 1 is often selected as the source of sheet supply.

While the continuous print processing is being executed, the roll paper supply device 1 may temporarily become unable to supply the first sheet 9a. For example, when the work of replenishing the roll paper 90 due to paper shortage or the work of clearing a jam of the roll paper 90 occurs, the roll paper supply device 1 is unable to supply the roll paper 90.

If a situation arises in which the roll paper supply device 1 is unable to supply the first sheet 9a, the productivity of the continuous print processing decreases.

In the present embodiment, the conveyance control portion 8b executes sheet supply control to be described later when the continuous print processing is executed. This makes it possible to maintain the productivity of the continuous print processing as much as possible even if the situation arises in which the roll paper supply device 1 is unable to supply the first sheet 9a.

### [Sheet Supply Control]

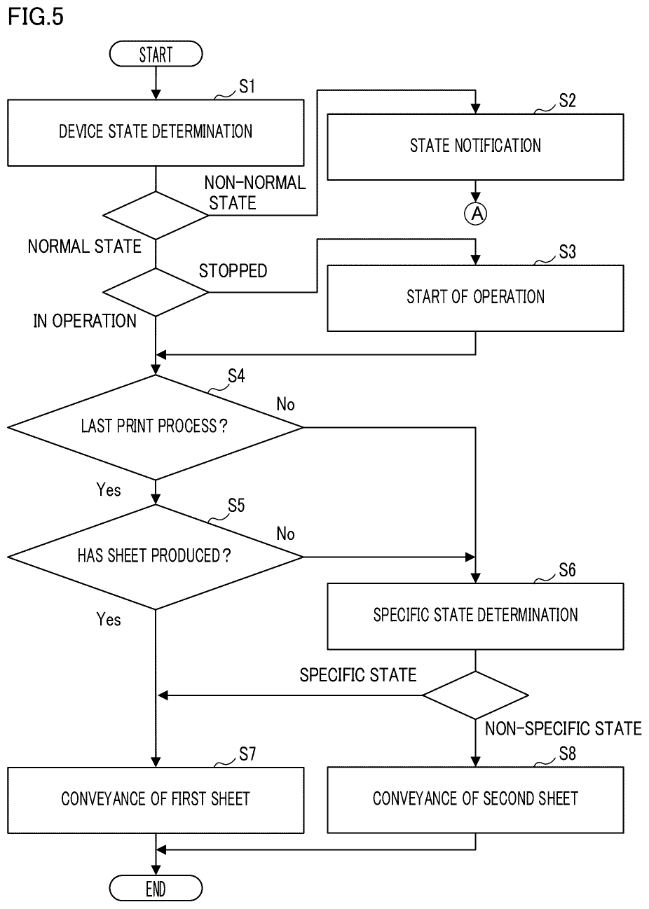

An example of the procedure of the sheet supply control will be described below with reference to the flowchart shown in FIG. 5.

The conveyance control portion 8b starts the sheet supply control when the main control portion 8a receives a request for the continuous print processing through the communication device 83 or the operation device 801.

The sheet supply control is an example of the processing for implementing an image formation control method for controlling the image forming apparatus 10. The CPU 80, which includes the conveyance control portion 8b, is an example of the processor that implements the image formation control method.

In the following description, S1 to S8 represent identification codes of a plurality of steps in the sheet supply control. In the sheet supply control, the process of step S1 is executed first.

The conveyance control portion 8b executes the processes of steps S1 to S8 for each print process in the continuous print processing.

For example, the conveyance control portion 8b executes the processes of steps S1 to S8 for the first time when a request for the continuous print processing occurs. Further, the conveyance control portion 8b executes the processes of steps S1 to S8 at a timing corresponding to a predetermined sheet interval, every time the print process is executed.

### <Step S1>

In step S1, the conveyance control portion 8b determines the state of the roll paper supply device 1.

Specifically, the conveyance control portion 8b determines whether the roll paper supply device 1 is in a normal state in which the roll paper supply device 1 is able to supply the first sheet 9a.

When it is determined that the roll paper supply device 1 is in the normal state, the conveyance control portion 8b determines whether the roll paper supply device 1 is in operation or stopped.

For example, the conveyance control portion 8b determines whether or not the roll paper supply device 1 is in the normal state in accordance with whether or not the detection states of the three sheet sensors 5a to 5c satisfy a sheet abnormality condition.

For example, the sheet abnormality condition includes a sheet out condition in which the first sheet sensor 5a does not detect the rolled-out portion 9x of the roll paper 90.

Further, the sheet abnormality condition may include a jam condition in which the detection result of the second sheet sensor 5b or the third sheet sensor 5c does not show a normal change in accordance with the operation of conveying the rolled-out portion 9x or the first sheet 9a.

Further, the roll paper supply device 1 may include a cover that can be opened and closed and a cover sensor for detecting the cover open state. The cover open state is a state in which the cover is opened. In this case, the conveyance control portion 8b determines that the roll paper supply device 1 is not in the normal state when the cover sensor detects the cover open state.

The conveyance control portion 8b executes the process of step S2 when it is determined that the roll paper supply device 1 is not in the normal state. The conveyance control portion 8b executes the process of step S3 when it is determined that the roll paper supply device 1 is in the normal state and that the roll paper supply device 1 is stopped.

On the other hand, the conveyance control portion 8b executes the process of step S4 when it is determined that the roll paper supply device 1 is in the normal state and that the roll paper supply device 1 is in operation.

### <Step S2>

In step S2, the conveyance control portion 8b executes a state notification process of notifying the user of the state determined in step S1.

For example, the conveyance control portion 8b notifies, through the communication device 83, the host device 7 of a message indicating the state determined in step S1. Alternatively, the conveyance control portion 8b notifies the user of the message through the display device 802.

The conveyance control portion 8b executes the process of step S8 after executing the process of step S2.

### <Step S3>

In step S3, the conveyance control portion 8b causes the roll paper supply device 1 to start operation. Thus, the roll paper supply device 1 sequentially executes the rollout process of the roll paper 90, the cutting process of the rolled-out portion 9x, and the conveying process of the first sheet 9a in accordance with the detection states of the three sheet sensors 5a to 5c.

The conveyance control portion 8b executes the process of step S4 after executing the process of step S3.

### <Step S4>

In step S4, the conveyance control portion 8b selects the next process in accordance with whether or not the print process to be executed is the last print process in the continuous print processing.

When the print process to be executed is the last print process, the conveyance control portion 8b executes the process of step S5. On the other hand, when the print process to be executed is not the last print process, the conveyance control portion 8b executes the process of step S6.

### <Step S5>

In step S5, the conveyance control portion 8b determines whether or not the roll paper supply device 1 is in a sheet produced state. The sheet produced state is a state in which the first sheet 9a has already been produced by the roll paper supply device 1.

The conveyance control portion 8b determines whether or not the roll paper supply device 1 is in the sheet produced state in accordance with the detection states of the second sheet sensor 5b and the third sheet sensor 5c and the operation record of the cutting device 12.

The conveyance control portion 8b determines that the roll paper supply device 1 is in the sheet produced state every time the cutting device 12 executes a cutting operation in a state in which the rolled-out portion 9x is detected by the second sheet sensor 5b.

On the other hand, the conveyance control portion 8b determines that the roll paper supply device 1 is not in the sheet produced state every time the third sheet sensor 5c changes from the state of detecting the first sheet 9a to the state of not detecting the first sheet 9a.

When it is determined that the roll paper supply device 1 is in the sheet produced state, the conveyance control portion 8b executes the process of step S7. On the other hand, when it is determined that the roll paper supply device 1 is not in the sheet generated state, the conveyance control portion 8b executes the process of step S6.

### <Step S6>

In step S6, the conveyance control portion 8b determines whether or not the roll paper supply device 1 is in a specific state in which the roll paper supply device 1 has conveyed the first sheet 9a to the specific position P2.

The specific state is a state in which the first sheet 9a has reached the specific position P2. The non-specific state, which is not the specific state, is a state in which the first sheet 9a has not reached the specific position P2.

The conveyance control portion 8b determines that the roll paper supply device 1 is in the specific state when the first sheet 9a is detected by the third sheet sensor 5c. On the other hand, when the first sheet 9a is not detected by the third sheet sensor 5c, the conveyance control portion 8b determines that the roll paper supply device 1 is not in the specific state.

The conveyance control portion 8b executes the process of step S7 when it is determined that the roll paper supply device 1 is in the specific state. On the other hand, the conveyance control portion 8b executes the process of step S8 when it is determined that the roll paper supply device 1 is not in the specific state.

### <Step S7>

In step S7, the conveyance control portion 8b causes the first feeding mechanism 13 of the roll paper supply device 1 to convey the first sheet 9a toward the print position P1. Thus, the first sheet 9a is conveyed to the print position P1 by the pre-stage conveying mechanism 22 and the relay conveying mechanism 31, and an image is formed on the first sheet 9a.

After executing the process of step S7, the conveyance control portion 8b ends the sheet supply control corresponding to one print process.

### <Step S8>

In step S8, the conveyance control portion 8b causes the second feeding mechanism 21 of the cut sheet supply device 2 to execute a process of conveying the second sheet 9b toward the print position P1. Thus, the second sheet 9b is conveyed to the print position P1 by the pre-stage conveying mechanism 22 and the relay conveying mechanism 31, and an image is formed on the second sheet 9b.

After executing the process of step S8, the conveyance control portion 8b ends the sheet supply control corresponding to one print process.

Here, the period from when the control device 8 receives a request for the continuous print processing to when the last print process in the continuous print processing is executed is referred to as a sheet feed operation period.

The conveyance control portion 8b repeatedly executes the processes of steps S1 to S8 for each print process during the sheet feed operation period. As described above, the process of step S1 includes a process of determining whether or not the roll paper supply device 1 is in the normal state.

By executing the process of step S3, the conveyance control portion 8b causes the roll paper supply device 1 to repeatedly execute a first sheet preparation process when it is determined that the roll paper supply device 1 is in the normal state during the sheet feed operation period. The first sheet preparation process is a process of producing the first sheet 9a and conveying the first sheet 9a to the specific position P2.

By executing the sheet supply control, the productivity of the continuous print processing is maintained even in the event that the roll paper supply device 1 is not in the normal state.

In addition, the conveyance control portion 8b executes the process of step S5 when the last print process in the continuous print processing is executed. In step S5, when it is determined that the roll paper supply device 1 is in the sheet produced state, the conveyance control portion 8b causes the roll paper supply device 1 to execute the process of step S7 regardless of the conveyance position of the first sheet 9a.

Accordingly, it is avoided that the produced first sheet 9a remains in the roll paper supply device 1 in vain when the continuous print processing is completed.

### Application Example

In the image forming apparatus 10 described above, the printing device 3 executes the print process using an inkjet method. However, an apparatus that executes the print process using another method such as an electrophotographic method may be employed as the printing device 3.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image formation control method for controlling an image forming apparatus including: a roll paper supply device configured to roll out roll paper and cut a rolled-out portion of the roll paper to produce a first sheet of a specific size, and convey the first sheet toward a print position; a cut sheet supply device configured to convey a second sheet of the specific size accommodated in an accommodating portion toward the print position; and a printing device configured to execute a print process of forming an image on the first sheet or the second sheet at the print position, the image formation control method comprising:
when continuous print processing in which the print process is repeated a plurality of times is executed,
determining, by a control device, whether or not the roll paper supply device is in a specific state in which the roll paper supply device has conveyed the first sheet to a specific position, for each of the print processes;
causing, by the control device, the roll paper supply device to execute a process of conveying the first sheet toward the print position when it is determined that the roll paper supply device is in the specific state, for each of the print processes; and
causing, by the control device, the cut sheet supply device to execute a process of conveying the second sheet toward the print position when it is determined that the roll sheet supply device is not in the specific state, for each of the print processes.

2. The image formation control method according to claim 1, further comprising:
determining, by the control device, whether or not the roll paper supply device is in a sheet produced state in which the roll paper supply device has already produced the first sheet when a last print process of the print processes in the continuous print processing is executed; and
causing, by the control device, the roll paper supply device to execute a process of conveying the first sheet toward the print position regardless of a conveyance position of the first sheet when it is determined that the roll paper supply device is in the sheet produced state when a last print process of the print processes in the continuous print processing is executed.

3. The image formation control method according to claim 1, further comprising:
repeatedly determining, by the control device, whether or not the roll paper supply device is in a normal state in which the roll paper supply device is able to supply the first sheet in a sheet feed operation period from when the control device receives a request for the continuous print processing to when a last print process of the print processes in the continuous print processing is executed; and
repeatedly causing, by the control device, the roll paper supply device to execute a process of producing the first sheet and conveying the first sheet to the specific position when it is determined that the roll paper supply device is in the normal state during the sheet feed operation period.

4. An image forming apparatus comprising:
a roll paper supply device configured to roll out roll paper and cut a rolled-out portion of the roll paper to produce a first sheet of a specific size, and convey the first sheet toward a print position;
a cut sheet supply device configured to convey a second sheet of the specific size accommodated in an accommodating portion toward the print position;
a printing device configured to execute a print process of forming an image on the first sheet or the second sheet at the print position; and
a control device configured to implement the image formation control method according to claim 1.
